(19) United States
(12) Patent Application Publication
(10) Pub. No.: US 2006/0012796 A1
(43) Pub. Date: Jan. 19, 2006

(54) Plasma treatment apparatus and light detection method of a plasma treatment

(76) Inventors: Susumu Saito, Yamanashi (JP); Andrew Weeks Kueny, Dallas, TX (US)

Correspondence Address: RUDOLPH J. BUCHEL JR., LAW OFFICE OF, P. O. BOX 702526, DALLAS, TX, 75370-2526, US

(21) Appl. No.: 10/890,687

(22) Filed: Jul. 14, 2004

(51) Int. Cl. G01B 9/02

(52) U.S. Cl. 356/451

(57) ABSTRACT

The subject of the invention is a plasma treatment apparatus and light detection method capable of detecting multiple optical signals obtained from multiple measurement locations and capable of analyzing condition of each of the measurement locations using an apparatus having the advantage of having a more simplified structure.

Interference light L1 passes through optical fiber 222 and is transmitted to spectroscopic component 230. Plasma light L2 passes through optical fiber 224 and is transmitted to spectroscopic component 230. These lights separately undergo respective spectroscopic separation. Interference light spectrum L1g obtained by spectroscopic separation of interference light L1 passes through first light path 226 and strikes an interference light photoreception region of photoelectric conversion component 240. Plasma light spectrum L2g obtained by spectroscopic separation of plasma light L2 passes through second light path 228 and strikes a plasma light photoreception region of photoelectric conversion component 240.

### BACKGROUND OF THE INVENTION

1. Technical Field Relating to the Invention

The present invention relates to a plasma treatment apparatus and a light detection method of a plasma treatment apparatus.

2. Conventional Technology

Etching treatment by plasma is widely used for the production processes of semiconductor devices and LCD (Liquid Crystal Display) substrates. The treatment apparatus utilized for this plasma treatment, for example, is equipped with an upper electrode and a lower electrode disposed parallel to one another. While the treatment workpiece (e.g. a semiconductor wafer) is carried and held on the lower electrode, plasma is generated between the upper electrode and the lower electrode. The treatment workpiece is subjected to etching of a certain pattern by this plasma.

Scale of the holes and trenches formed by plasma treatment is currently being reduced. This requires real-time observation of the treatment apparatus operating state and more highly precise detection of the endpoint of etching.

Conventional detection of the endpoint of etching has widely utilized the high sensitivity spectroscopic analysis method due to its relative simplicity (see Japanese publication of unexamined patent application no. 2000-331985 (JP2000331985)). According to this spectroscopic analysis method, a specific active species is selected among active species such as ions, etc. (e.g. CO*, N*, etc.), radicals of reaction products, etc., of the gas used for etching or decomposition products thereof. The endpoint of etching is detected based on variation of the emission spectrum of the selected specific active species (emission intensity at each wavelength). For example, if a silicon oxide film is etched using a fluorocarbon type (CF₄, etc.) etchant gas, the emission spectrum from the reaction product CO* (219 nm, 483.5 nm, etc.) is measured. Moreover, if a silicon nitride film is etched using a fluorocarbon-type etchant gas, the emission spectrum from the reaction product N* (674 nm, etc.) is measured. Then the etching endpoint is determined by comparison of emission intensity at the above mentioned type of specific wavelength, or the value of the first, second, etc. differential of such emission intensity, with a previously established value.

Moreover, according to this spectroscopic analysis method, plasma light during etching treatment is measured sequentially from the lateral direction. This measured emission spectrum of the plasma and data detected from other parts of the treatment apparatus (e.g., electrical power of the upper/lower electrode, temperature of the upper/lower electrode, internal wall temperature of the treatment apparatus, etc.) are used (e.g. by multi-variable analysis) to make possible real-time observation of operating state of the treatment apparatus.

However, the spectroscopic analysis method determines the endpoint of etching by variation of intensity of the plasma light generated when a layer (referred to hereinafter as the “underlying layer”) below the layer subject to treatment becomes exposed by etching. Thus there is concern that the underlying layer may be removed (so-called “over etching”), particularly when the etch rate is high.

For the case when etching treatment is not ended simultaneously with exposure of the underlying layer, or for the case when etching treatment is ended while leaving behind a certain thickness of the layer under treatment without exposure of the underlying layer, a method other than the spectroscopic analysis method is used. For example, a method that measures interference light (referred to hereinafter as the “interference light measurement method”) illuminates the layer under treatment of the treatment workpiece (layer subject to etching) with light and measures the. interference light generated by reflection from the layer subject to treatment (see Japanese publication of unexamined patent application no. Hei 3-283165 (JP3283615) and Japanese publication of unexamined patent application no. 2000-212773 (JP200021273)). If the interference light measurement method is adopted, it becomes possible even to detect directly the rate of etching of the layer under treatment during etching.

In order to detect the etching endpoint with higher precision, and to furthermore observe etching rate of the layer under treatment and operating state, etc. of the treatment apparatus in real time, it is desirable to use a treatment apparatus that incorporates several optical measurement methods as represented by the spectroscopic analysis method and the interference light measurement method.

### SUMMARY OF THE INVENTION

Advantages to be Afforded by the Invention

However, when for example, detection of etching endpoint and etching rate of the layer under treatment are attempted using the spectroscopic analysis method and the interference light measurement method, it has been necessary to separately incorporate in the treatment apparatus optical system components for the spectroscopic analysis method and optical system components for the interference light measurement method. As a result, scale of the treatment apparatus increases, the space occupied by the treatment apparatus must be increased, and the cost of the treatment apparatus is increased.

The present invention was developed in consideration of the above mentioned considerations. The object of the present invention is to provide a novel and improved plasma treatment apparatus and light detection method for a plasma treatment apparatus, wherein the plasma treatment apparatus is capable of detecting multiple optical signals obtained from multiple measurement locations and is capable of analyzing conditions at each of the measurement locations using an apparatus of more simplified structure.

Means to Realize the Advantages

According to a first aspect of the present invention in order to realize the above mentioned advantages, a plasma treatment apparatus is provided for carrying out plasma treatment of a treatment workpiece in a treatment chamber, wherein the apparatus comprises the following: a first light path for transmission of interference light obtained by reflection at multiple faces of the treatment workpiece by light striking the treatment workpiece within the treatment chamber, a second light path for transmission of plasma light generated by plasma formed in the treatment chamber, a spectroscopic component for spectroscopically separating the interference light and the plasma light, and a photoelectric conversion component having a photoelectric conversion element region constructed as a two-dimensional array of multiple photoelectric conversion elements for conversion of incident light from the spectroscopic component into electrical charge and an electrical charge storage member for storage of electrical charge sent from the photoelectric conversion element region; wherein the photoelectric conversion element region of the photoelectric conversion component has at least the following: an interference light photoreception region for photoreception of the interference light spectroscopically separated at the spectroscopic component, and a plasma light photoreception region for photoreception of the plasma light spectroscopically separated at the spectroscopic component.

According to the plasma treatment apparatus having this structure, the photoelectric conversion element region having the interference light photoreception region and the plasma light photoreception region receives interference light and plasma light. Thus there is no need for preparation of separate respective photoelectric conversion components for interference light and for plasma light. This results in a size reduction of the plasma treatment apparatus.

Moreover, the above mentioned photoelectric conversion component has an electric charge storage member for storing electrical charge transmitted from the photoelectric conversion element region. The electric charge generated by those photoelectric conversion elements belonging to the interference light photoreception region is transmitted to the electric charge storage member through the plasma light photoreception region. Due to this structure, electric charge generated by photoelectric conversion elements belonging to the interference light photoreception region does not require securing a separate path for transmission to the electric charge storage member, and this results in a size reduction of the plasma treatment apparatus.

If considerable electric charge is sent at one time to the electric charge storage member, there is concern that the electric charge storage member would lapse into an overflow state. With respect to this point, according to the present invention, the electrical charge group obtained by photoelectric conversion of the plasma light undergoes time-wise division and is in sent to the electrical charge storage member (i.e., it is subdivided and sent in two successive steps). It is therefore possible to store all of the sent electrical charge without increasing capacity of the electrical charge storage member. The frequency of such transmission is preferably determined according to capacity of the electrical charge storage member.

The above mentioned photoelectric conversion element region preferably has a light-shielded region that overlaps neither the interference light photoreception region nor the plasma light photoreception region. By sending the photoelectric-converted electrical charge group to the light-shielded region from the interference light photoreception region and plasma light photoreception region, it becomes possible to continuously receive interference light in the interference light photoreception region, and it becomes possible to continuously receive plasma light in the plasma light photoreception region. Moreover, since external light does not strike the light-shielded region, it is possible to maintain electrical charge groups sent from the interference light photoreception region and the plasma light photoreception region in a stabilized state.

According to a second aspect of the present invention, in order to solve the above mentioned problems, a light detection method of a plasma treatment apparatus is provided, wherein the plasma treatment apparatus for carrying out plasma treatment of a treatment workpiece in a treatment chamber comprises the following: a first light path for transmission of interference light obtained by reflection at multiple faces of the treatment workpiece by light striking the treatment workpiece within the treatment chamber, a second light path for transmission of plasma light generated by plasma formed in the treatment chamber, a spectroscopic component for spectroscopically separating the interference light and the plasma light, and a photoelectric conversion component having a photoelectric conversion element region constructed as a two-dimensional array of multiple photoelectric conversion elements for conversion of incident light from the spectroscopic component into electrical charge; wherein the method has a step of receiving, at the interference light photoreception region established in the photoelectric conversion element region, the interference light having been spectroscopically separated by the spectroscopic component, and receiving, at the plasma light photoreception region established in the photoelectric conversion element region so as to not overlap the interference light photoreception region, the plasma light having been spectroscopically separated by the spectroscopic component.

According to this light detection method, it becomes possible to detect interference light and plasma light by a single photoelectric conversion component without provision of separate respective photoelectric conversion components for the interference light and the plasma light, and this results in a size reduction of the plasma treatment apparatus.

Furthermore, the electrical charge group obtained by photoelectric conversion of plasma light is sent to the electrical charge storage member from the plasma light photoreception region, and the electrical charge group obtained from the interference light is preferably sent to the electrical charge storage member through the plasma light photoreception region from the interference light photoreception region. The electrical charge group generated by photoelectric conversion elements belonging to the interference light photoreception region is sent to the electrical charge storage member without the need for securing a separate route, and this results in a size reduction of the photoelectric conversion component.

### BRIEF DESCRIPTION OF THE DRAWINGS

FIG. 1 is a schematic cross-sectional diagram showing structure of the etching apparatus according to a working example of the present invention;

FIG. 2 is a block diagram showing structure of the light detection component provided for the etching apparatus according to the same working example;

FIG. 3 is a cross-sectional drawing showing structure of the spectroscopic component provided for the light detector component shown in FIG. 2;

FIG. 4 is a tilted-perspective drawing showing structure of the spectroscopic component provided for the light detector component shown in FIG. 2;

FIG. 5 is a block diagram showing structure of the photoelectric conversion component provided for the light detector component shown in FIG. 2;

FIG. 6 is a block diagram showing operation (step S01) of the photoelectric conversion component shown in FIG. 5;

FIG. 7 is a block diagram showing operation (step S02) of the photoelectric conversion component shown in FIG. 5;

FIG. 8 is a block diagram showing operation (step S03) of the photoelectric conversion component shown in FIG. 5;

FIG. 9 is a block diagram showing operation (step S04) of the photoelectric conversion component shown in FIG. 5;

FIG. 10 is a block diagram showing operation (step S05) of the photoelectric conversion component shown in FIG. 5;

FIG. 11 is a block diagram showing operation (step S06) of the photoelectric conversion component shown in FIG. 5;

FIG. 12 is a block diagram showing operation (step S07) of the photoelectric conversion component shown in FIG. 5;

FIG. 13 is a block diagram showing operation (step S08) of the photoelectric conversion component shown in FIG. 5;

FIG. 14 is a block diagram showing operation (step S09) of the photoelectric conversion component shown in FIG. 5; and

FIG. 15 is a block diagram showing operation (step S10) of the photoelectric conversion component shown in FIG. 5.

Explanation of Items

| | | |
|---|---|---|
| 100 | . . . | etching apparatus |
| 102 | . . . | treatment chamber |
| 105 | . . . | susceptor |
| 111 | . . . | electrostatic chuck |
| 121 | . . . | upper electrode |
| 161 | . . . | window |
| 171 | . . . | window |
| 200 | . . . | light detector component |
| 210 | . . . | light source |
| 220 | . . . | optical fiber |
| 222 | . . . | optical fiber |
| 224 | . . . | horizontal shift register |
| 226 | . . . | first light path |
| 228 | . . . | second light path |
| 230 | . . . | spectroscopic component |
| 232 | . . . | slit |
| 234 | . . . | grating |
| 240 | . . . | photoelectric conversion component |
| 242 | . . . | photoelectric conversion element part |
| 242-1 | . . . | interference light photoreception region |
| 242-2 | . . . | plasma light photoreception region |
| 242-3 | . . . | light-shielded region |
| 244 | . . . | horizontal shift register |
| 250 | . . . | calculation treatment component |
| L0 | . . . | irradiating light |
| L1 | . . . | interference light |
| L2 | . . . | plasma light |
| L10 | . . . | plasma light |
| L1g | . . . | interference light spectrum |
| L2g | . . . | plasma light spectrum |
| L1s | . . . | slit interference light |
| L2s | . . . | slit plasma light |
| P | . . . | plasma |
| S240 | . . . | optical detection signal |
| W | . . . | wafer |

### DETAILED DESCRIPTION OF THE INVENTION

### WORKING EXAMPLES

Preferred embodiments of the plasma treatment apparatus and the plasma treatment apparatus light detection method according to the present invention are explained below while referring to the appended figures. Furthermore, within the present specification document and the figures, constituent elements having substantially the same mechanical structure are assigned the same identifying number, and redundant explanations are omitted.

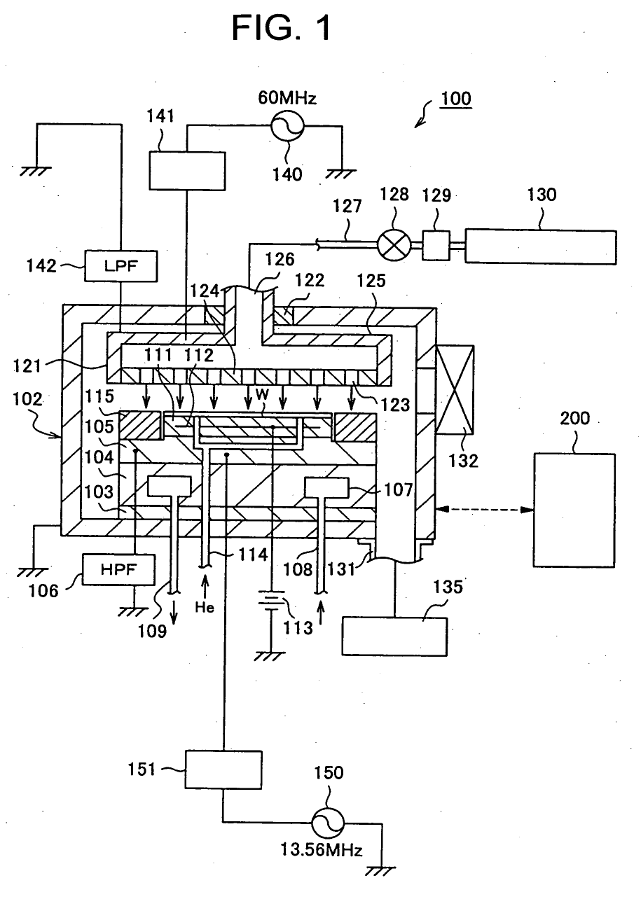

Structure of an etching apparatus 100, as a plasma treatment apparatus that is a working example of the present invention, is explained while referring to figures. FIG. 1 is a cross-sectional schematic drawing showing structure of etching apparatus 100. Etching apparatus 100 is constructed as a capacitively-coupled flat-plate etching apparatus having upper and lower parallel opposing electrodes for which one electrode contacts the power source used for plasma formation.

This etching apparatus 100 has a treatment chamber (chamber) 102 formed as a tubular shape from aluminum having undergone anodic oxidation treatment (alumite treatment). This treatment chamber 102 is grounded. A roughly cylindrical pillar-shaped susceptor support pedestal 104 is provided for carrying and holding a wafer W as the treatment workpiece via an insulating plate 103 of ceramic, etc. at the bottom of the interior of treatment chamber 102. On this susceptor support pedestal 104 is provided a susceptor (referred to hereinafter as the lower electrode) forming the bottom electrode. This susceptor 105 is connected to a high pass filter (HPF) 106.

Within susceptor support pedestal 104 is provided a temperature control medium chamber 107. A temperature control medium is fed to temperature control medium chamber 107 via a feed line 108, is circulated, and then is discharged from discharge line 109. It becomes possible to control susceptor 105 at a desired temperature by circulation of the temperature control medium in this manner.

Susceptor 105 is formed as a circular plate having a central protuberance on the top. Thereon is disposed an electrostatic chuck 111 of roughly the same shape as that of wafer W. Electrostatic chuck 111 is constructed as an electrode 112 disposed between insulation material. Electrostatic chuck 111 draws-attaches wafer W by static electric force by application of a direct current voltage (e.g. 1.5 kV) from a direct current power source 113 connected to electrode 112.

Then insulating plate 103, susceptor support pedestal 104, susceptor 105, and also electrostatic chuck 111 form a gas flow route 114 for supply of a heat conduction medium (backside gas such as He and the like) to the backside face of wafer W which is the treatment workpiece. Furthermore, this heat conduction medium conducts heat between susceptor 105 and wafer W so as to maintain wafer W at a certain temperature.

At the upper perimeter edge part of susceptor 105, a focus ring 115 of annular shape is disposed so as to surround the substrate W which is carried and held on electrostatic chuck 111. This focus ring 115 is formed of an insulating or conductive material so as to improve uniformity of etching.

Moreover, the upper electrode 121 is disposed facing and parallel with this susceptor 105 above susceptor 105. This upper electrode 121 is held in the interior of treatment chamber 102 by an insulator 122. The upper electrode 121 comprises, on the surface facing susceptor 105, an electrode plate 124 having a number of jet apertures 123, and an electrode support body 125 for supporting this electrode 124. The above mentioned electrode plate is constructed, for example, of quartz. The above mentioned electrode support body 125, for example, is constructed from an electrically conductive material such as aluminum having undergone alumite surface treatment. Furthermore, the gap between susceptor 105 and upper electrode 121 is made to be adjustable.

A gas inlet port 126 is provided at the center of electrode support body 125 of upper electrode 121. This gas inlet port 126 is connected to a gas supply line 127. Furthermore, this gas supply line 127 is connected to a treatment gas supply apparatus 130 via a valve 128 and a mass flow controller 129.

Etching gas for plasma etching is supplied from this treatment gas supply apparatus 130. Furthermore, although FIG. 1 shows only a single supply system for treatment gas (comprising the above mentioned treatment gas supply apparatus 130, etc.), this can be constructed as a plurality of such treatment gas supply systems having respective independent flow control of gases such as C₄F₆, CF₄, Ar, O₂, and the like for feeding to the interior of treatment chamber 102.

An exhaust gas line is connected to the bottom of treatment chamber 102. This exhaust gas line 131 is connected to an exhaust gas device 135. The exhaust gas device 135 is equipped with a vacuum pump, such as a turbo molecular pump, constructed so as to make possible pulling a vacuum down to a certain reduced pressure (e.g. less than or equal to 0.67 Pa) in the interior of treatment chamber 102. Moreover, a gate valve 132 is provided at a side wall of treatment chamber 102.

A first high frequency power supply 140 is connected to upper electrode 121. A rectifier 141 is inserted in this power supply line. Moreover, a low pass filter (LPF) 142 is connected to this upper electrode 121. This first high frequency power supply 140 has a frequency in the range of 50-150 MHz. By application of electrical power at this type of high frequency, it is possible to form a high density plasma of the desired disassociation state in the interior of treatment chamber 102, and it becomes possible to perform more plasma treatment under still lower pressure conditions than was previously possible. The frequency of this first high frequency power supply 140 is preferably 50-80 MHz, and typically a frequency of 60 MHz is utilized, as shown in the figure, or a frequency in the vicinity of this frequency.

A second high frequency power supply 150 is connected to susceptor 105 as the lower electrode. A rectifier 151 is placed in this electrical supply line. The second high frequency power supply 150 has a frequency in the range of several hundred kHz to ten MHz or more. By application of a frequency in this range, it is possible to impart proper ion effects without damaging the wafer W which is the treatment workpiece. Typically a frequency of 13.56 or 2 MHz, etc. is adopted as shown in the figure for the frequency of the second high frequency power supply 150.

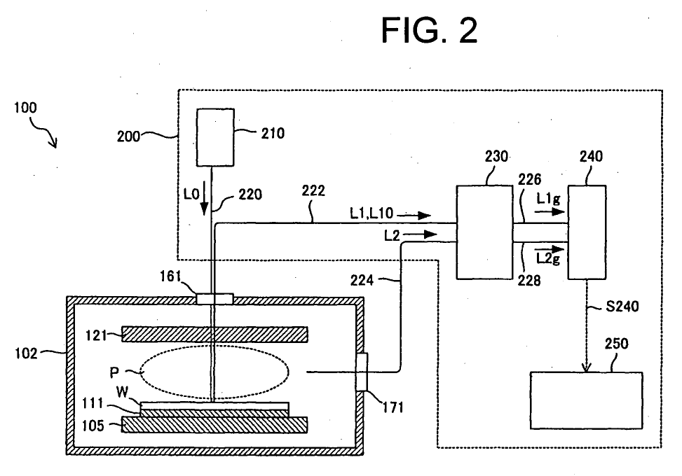

The etching apparatus 100 of the present working example is equipped with a light detector component 220 for detection of multiple optical signals obtained from multiple parts under observation in the interior of treatment chamber 102. The structure and function of this light detector component 200 is explained while referring to FIG. 2.

For the present working example, light detector component 200, as shown in FIG. 2, is equipped with a light source 210, a spectroscopic component 230, a photoelectric conversion component 240, and a calculation treatment component 250. Due to such construction, it becomes possible to observe thickness or depth of a layer under observation formed on the wafer W (i.e. a layer subject to etching), and it becomes possible to observe the state of plasma P formed in treatment chamber 102.

Irradiating light LO emanating from light source 210 passes through an optical fiber 220, passes through window 161 provided at the upper part of treatment chamber 102, and strikes the surface of wafer W in the interior of treatment chamber 102. For example, a layer subject to etching (not shown in the figure) as the layer under observation is formed on wafer W. Irradiating light L0 is reflected from an interface between the layer subject to etching and a mask layer (not shown in the figure) shielding the layer subject to etching. This light also reflects from the bottom surface of a hole formed by etching in the layer subject to etching. Interference light L1 obtained by interference between these two reflected light beams passes through window 161, passes through an optical fiber 222, and is sent to spectroscopic component 230. Intensity of the interference light L1 varies in response to the depth of the hole (i.e. the degree of etching). Therefore it is possible to measure etching rate based on detection of the interference light L1.

When wafer W undergoes a certain treatment (e.g. when subjected to etching treatment), plasma P is formed between upper electrode 121 and wafer W in the interior of treatment chamber 102. Plasma light L2 generated by this plasma P passes through a window 171 provided at the side of treatment chamber 102, passes through an optical fiber 224, and is sent to spectroscopic component 230.

However, plasma light L10 generated by plasma P travels through widow 161 provided at the upper part of treatment chamber 102 and strikes optical fiber 222 which transmits interference light L1. That is to say, during the time interval when irradiating light L0 is output from light source 210, the interference light L1 transmitted by optical fiber 222 includes plasma light L10. In contrast, during the time interval when irradiating light L0 is not output from light source 210, optical fiber 222 only transmits plasma light L10.

Furthermore, optical components (lenses, mirrors, and the like) may be disposed in the light path of irradiating light L0, interference light L1 (plasma light L10), and plasma light L2, and these components may be constructed such that each optical axis can be adjusted. Moreover, it is possible to construct each light path without utilizing optical fibers 220, 222, and 224.

Interference light L1 together with plasma light L2 are introduced to spectroscopic component 230, and these light beams undergo spectroscopic separation. An interference light spectrum L1g, obtained by spectroscopic separation of interference light L1, passes through a first light path 226 and strikes a photoreception face of photoelectric conversion component 240. Plasma light spectrum L2g, obtained by spectroscopic separation of plasma light L2, passes through a second light path 228 and strikes the photoreception face of photoelectric conversion component 240.

Photoelectric conversion component 240 outputs an optical detection signal S240 to calculation treatment component 250. The calculation treatment component 250 carries out a certain calculation treatment utilizing this optical detection signal S240. Etching apparatus 100, based on results of calculation treatment of calculation treatment component 250, observes, for example, thickness of the layer subject to etching and condition of plasma P in real time. Thus it becomes possible, for example, to end etching treatment of the layer subject to etching prior to exposure of the underlying layer. Moreover, since it is possible to detect exposure of the underlying layer based on both change of thickness of the layer subject to etching and change of condition of plasma P, it becomes possible to complete etching simultaneously with exposure of the underlying layer without etching the underlying layer. Furthermore, since it is possible to understand operating state of etching apparatus 100 based on change of the condition of plasma P, automatically process control becomes possible by adjustment of the flow rate of treatment gas and the like.

Furthermore, although a halogen lamp (e.g. a xenon lamp) may be used as light source 210, it is also permissible to use an LED lamp. Among such xenon lamps, use of a lamp suitable for turning ON/OFF over short time intervals is preferred (e.g. a xenon flash lamp having a major electrode and a trigger probe). An LED lamp is preferred as light source 210 due to capability for ON/OFF operation over short time intervals and longer run life and lower power consumption than a xenon lamp.

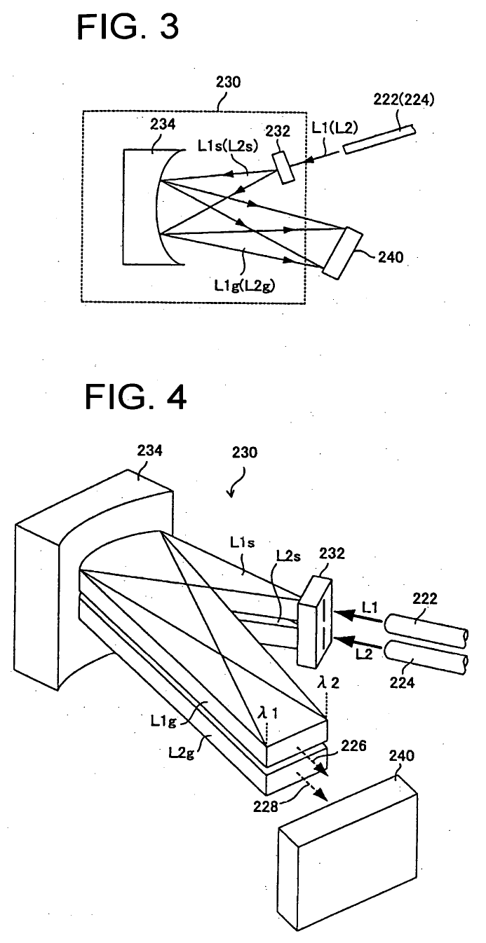

Structure of spectroscopic component 230 will be explained next while referring to FIG. 3 and FIG. 4. FIG. 3 is a top planar view of spectroscopic component 230. FIG. 4 is a tilted-perspective view of spectroscopic component 230.

Spectroscopic component 230 comprises a slit 232 and a grating 234. Interference light L1 passes through optical fiber 222 and is introduced to spectroscopic component 230. Plasma light L2 passes through optical fiber 224 and is introduced to spectroscopic component 230. These lights first pass through slit 232. Interference light L1 and plasma light L2 are light beams which are emitted radially from optical fiber 222 and optical fiber 224. This slit 232 is equipped with a slit hole used for interference light L1 and a slit hole used for plasma light L2. Interference light L1 is output as a slit interference light L1s, and plasma light L2 is output as a plasma light L2s. This slit 232 adjusts the quantity of interference light L1 and plasma light L2 and also prevents crosstalk (mutual interference) between slit interference light L1s and slit plasma light L2s.

Slit interference light L1s and slit plasma light L2s, having passed through slit 232 and having spread out, spread out perpendicularly to the slit direction of slit 232, arrive respectively at grating 234, and undergo spectroscopic separation there. The interference spectrum L1g obtained by spectroscopic separation of slit interference light L1s passes through a first light path 226 and is directed toward photoelectric conversion component 240. The plasma spectrum L2g obtained by spectroscopic separation of slit plasma light L2s passes through a second light path 228 and is directed toward photoelectric conversion component 240. The gap between first light path 226 and second light path 228 is adjusted so that crosstalk does not occur between interference light spectrum L1g and plasma light spectrum L2g at this time.

Furthermore, although a concave type grating is used as grating 234 for the present working example, a planar-type grating may be used. However, if a planar-type grating is used, an imaging element such as a concave mirror, lens and the like is also needed.

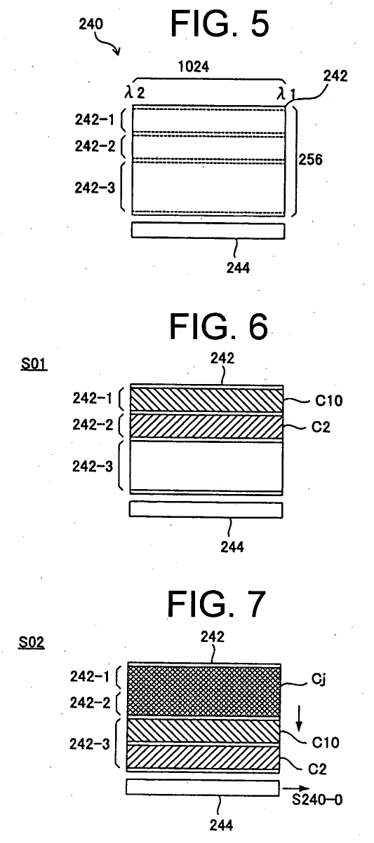

The photoelectric conversion component 240 positioned at the final stage of spectroscopic component 230 having this type of structure, as shown in FIG. 5, is equipped with a photoelectric conversion element part (photoelectric conversion element region) 242 for receiving light of interference light spectrum L1g and plasma light spectrum L2g (wherein this photoelectric conversion element part 242 stores electrical charge obtained from photoelectric conversion) and a horizontal shift register (electrical charge storage member) 244 for serial external output of the stored electrical charge.

Photoelectric conversion element part 242 is constructed as a two-dimensional array of multiple photoelectric conversion elements (not show in the figures). The photoelectric conversion element part 242 according to the present working example has 1024 photoelectric conversion elements (pixels) arrayed in the horizontal direction (X direction), and 256 photoelectric conversion elements (pixels) arrayed in the vertical direction (Y direction). A CCD (Charge-Coupled Device) or MOS (Metal-Oxide-Semiconductor) type photosensor can be used as the photoelectric conversion element.

The X direction of photoelectric conversion element part 242 corresponds to a wavelength range λ1-λ2 of interference light spectrum L1g and plasma light spectrum L2g. That is to say, photoelectric conversion element part 242 has the ability to detect all spectrum components of interference light spectrum L1g and plasma light spectrum L2g divided into 1024 parts.

Moreover, disposed in sequence along the Y direction at the photoreception face of photoelectric conversion element part 242 are an interference light photoreception region 242-1, a plasma light photoreception region 242-2, and a light-shielded region 242-3. For example, photoelectric conversion elements from the first line (row in the X direction) to line number 64 belong to interference light photoreception region 242-1, photoelectric conversion elements from line number 65 to line number 128 belong to plasma light photoreception region 242-2, and photoelectric conversion elements from line number 129 to line number 256 belong to shielded-light region 242-3. Although it is possible to adjust the number of lines of photoelectric conversion elements belonging to each region, the line count of photoelectric conversion elements belonging to light-shielded region 242-3 is preferably the same or larger than the line count of photoelectric conversion elements belonging to interference light photoreception region 242-1 and the line count of photoelectric conversion elements belonging to plasma light photoreception region 242-2.

Furthermore, by equipping photoelectric conversion element part 242 with another light reception region in addition to interference light photoreception region 242-1 and plasma light photoreception region 242-2, it becomes possible to detect other light together with interference light L1 and plasma light L2.

Interference light spectrum L1g output from spectroscopic component 230 strikes interference light photoreception region 242-1 of photoelectric conversion element part 242 and is subject to photoelectric conversion there. Plasma light spectrum L2g output from spectroscopic component 230 strikes plasma light photoreception region 242-2 of photoelectric conversion element part 242 and is subject to photoelectric conversion there. In contrast, the light reception face of light-shielded region 242-3 is shielded by a light shielding means (not shown in the figures). Interference light spectrum L1g, plasma light spectrum L2g, and of course other light do not strike light-shielded region 232-3.

Multiple photoelectric conversion elements belonging to photoelectric conversion element part 242 function also as a vertical shift register for shifting electrical charge obtained by photoelectric conversion in the Y direction. Specifically, simultaneous with a vertical shift operation control signal (not shown in the figures), a line number n (1≦n≦255) photoelectric conversion element transfers electrical charge to a line number n+1 photoelectric conversion element. Then simultaneous with the vertical shift operation control signal, a final line number 256 photoelectric conversion element transfers electrical charge to a horizontal shift register 224.

Horizontal shift register 244 does not simply store electrical charge from 1 line. It is possible for this register to add and store electrical charges of multiple lines for each column (Y direction column). Also horizontal shift register 244, after storing electrical charge of 1 line or of multiple lines, simultaneous with a horizontal shift operation control signal (not shown in the figures), outputs the stored charge as a serial light detection signal S240. This light detection signal S240 is given to calculation treatment component 250 in the above described manner, and this is used for a specific calculation (refer to FIG. 2).

According to etching apparatus 100 of the present working example constructed as described above, due to equipping photoelectric conversion element part 242 with an interference light photoreception region 242-1 and plasma light photoreception region 242-2, it becomes possible to detect interference light L1 and plasma light L2 by a single photoelectric conversion component 240.

Furthermore, etching apparatus 100 is provided with the light path (optical fiber 222, first light path 226) for transmission of interference light L1 (slit interference light L1s, interference light spectrum L1g) and the independent light path (optical fiber 224, second light path 228) for transmission of plasma light L1 (slit plasma light L2s, plasma light spectrum L2g). Thus there is no crosstalk between interference light spectrum L1g and plasma light spectrum L2g, and these lights arrive at interference light photoreception region 242-1 and plasma light photoreception region 242-2 respectively. Photoelectric conversion component 240 therefore detects interference light spectrum L1g and plasma light spectrum L2g with high precision.

Detection of interference light L1 and plasma light L2 during this treatment and operation for plasma etching treatment will be explained next as operations of etching apparatus 100. Furthermore, for the present working example, plasma etching treatment will be explained as an example of etching treatment of a silicon oxide layer (not shown in the figures) as a layer subject to treatment and formed on wafer W.

When wafer W undergoes plasma etching treatment, gate valve 132 is first opened, and wafer W is loaded into treatment chamber 102. The wafer is placed on electrostatic chuck 111. Thereafter gate value 132 is closed, and the interior of treatment chamber 102 is evacuated by exhaust gas device 135. Then valve 128 is opened, treatment gas is fed from treatment gas supply apparatus 130, and pressure of the interior of treatment chamber 102 becomes a certain pressure. Under these conditions, high frequency electrical power is supplied respectively from first high frequency power supply 140 and second high frequency power supply 150, the treatment gas is made to form a plasma, and this acts on wafer W.

Before and after timing of the supply of high frequency electrical power, the direct current power supply 113 is applied to electrode 112 in the interior of electrostatic chuck 111, and wafer W is electrostatically attached to electrostatic chuck 111. Moreover, during etching treatment, a cooling medium (chiller) is fed to temperature control medium chamber 107 at a temperature set to a certain temperature value, susceptor 105 is cooled, heat conduction medium (e.g. a backside gas such as He and the like) at a certain pressure is fed to the backside of wafer W, and the surface of wafer W is controlled at a certain temperature.

When etching apparatus 100 starts plasma etching treatment of wafer W, light detector component 200 starts detection of interference light L1 obtained from the silicon oxide layer that is the layer subject to treatment. The etched quantity (etching rate) of the silicon oxide layer is measured in this manner. Moreover, light detector component 200, in parallel with this interference light L1 detection operation, carries out detection of plasma light L2 emitted by plasma P formed in the interior of treatment chamber 102 in order to carry out plasma etching of wafer W.

Step-wise operation of detection by light detector component 200 during operation of plasma etching treatment by etching apparatus 100 will be explained while referring to FIG. 6-FIG. 15.

First, during step S01 (FIG. 6), while irradiating light L0 from light source 210 is not emitted (in the state during which interference light L1 is not generated), plasma light L10 passes through window 161 disposed at the upper part of treatment chamber 102 and enters optical fiber 222. Also plasma light L2 passes through window 171 disposed at the side part of treatment chamber 102, enters optical fiber 224, and is observed.

Plasma light L2 generated by plasma P formed in the interior of treatment chamber 102 passes through window 171 disposed at the wall part of treatment chamber 102, passes through optical fiber 224, and is transmitted to spectroscopic component 230. Spectroscopic component 230 spectroscopically separates plasma light L2 and forms the plasma light spectrum L2g having a wavelength range of λ1-λ2. This plasma light spectrum L2g strikes plasma light photoreception region 242-2 of photoelectric conversion element part 242 belonging to photoelectric conversion component 240, and photoelectric conversion to electrical charge group C2 occurs here.

However, as shown in FIG. 2, since interference light L1 traverses plasma P formed in the interior of treatment chamber 102, the interference light spectrum L1g finally striking photoelectric conversion component 240 also includes a plasma light L10 component. The plasma light L10 component must be removed in order to more accurately measure interference light L1. In consideration of this point, plasma light L10 is observed and measured during this step S01. This plasma light L10 undergoes spectroscopic separation by spectroscopic component 230 and strikes interference light photoreception region 242-1 of photoelectric conversion element part 242 belonging to photoelectric conversion component 240. Then this interference light photoreception region 242-1 carries out photoelectric conversion to electrical charge group C10.

Furthermore, since external light does not strike light-shielded region 242-3 of photoelectric conversion element part 242, the photoelectric conversion elements comprising light-shielded region 242-3 do not carry out photoelectric conversion. Therefore a new electrical charge does not arise at light-shielded region 242-3.

Then during step S02 (FIG. 7), electrical charge group C10 generated by interference light photoreception region 242-1 and electrical charge group C2 generated by plasma light photoreception region 242-2 are shifted collectively in the Y direction, and are temporarily stored at light-shielded region 242-3. If electrical charge has been stored in light-shielded region 242-3 beforehand, this electrical charge is sent to horizontal shift register 244 and stored. Horizontal shift register 244 carries out the horizontal shift operation at the time of completion of electrical charge transfer from light-shielded region 242-3, and the stored electrical charge is sent as a serial output as a light detection signal S240-0 to calculation treatment component 250. However, this light detection signal S240-0 is based on electrical charge stored beforehand at light-shielded region 242-3 of photoelectric conversion element part 242 and is unrelated to plasma light L10 and plasma light L2. Thus calculation treatment component 250 does not carry out calculation treatment based on this light detection signal S240-0.

Even after electrical charge group C10 generated at interference light photoreception region 242-1 and electrical charge group C2 generated at plasma light photoreception region 242-2 are sent to light-shielded region 242-3, photoelectric conversion elements belonging to interference light photoreception region 242-1 and photoelectric conversion elements belonging to plasma light photoreception region 242-2 generate respective electrical charge groups. However, since these electrical charge groups are generated during transmission of the electrical charge group C10 and electrical charge group C2 that had been previously generated, there is concern that a noise component may be intermixed. Thus this is treated as an electrical charge group (referred to hereinafter as a “junk electrical charge group”) Cj that is not used for detection of interference light L1 and plasma light L2.

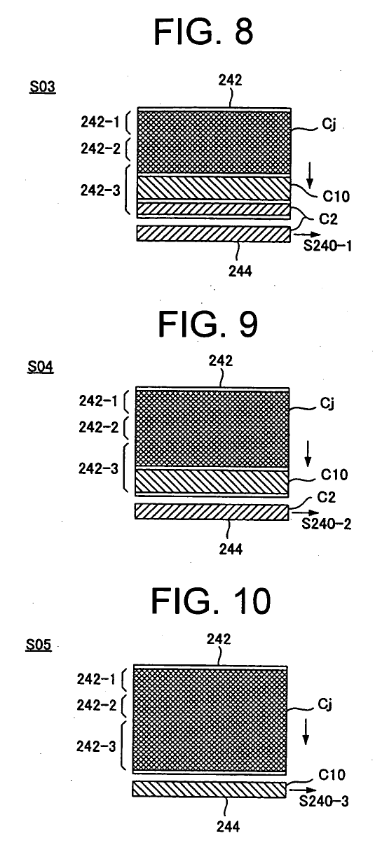

Then during step S03 (FIG. 8), among electrical charge groups sent to light-shielded region 242-3 from interference light photoreception region 242-1 and plasma light photoreception region 242-2, electrical charge group C2 is first sent to horizontal shift register 244. However, at this time when part of electrical charge C2 is stored in horizontal shift register 244, the shift operation in the Y direction is halted. If electrical charge group C2 is stored in 64 line parts of the photoelectric conversion element, 48 line parts of electrical charge group C2 equivalent to ¾ of 64 lines, for example, are sent from light-shielded region 242-3 to horizontal shift register 244. The horizontal shift register 244 adds and stores electrical charge groups C2 for 48 lines in each column (Y direction column).

Following transfer of the 48 line parts of electrical charge group C2 to horizontal shift register 244, the remaining 16 line parts of electrical charge group C2, electrical charge group C10, and junk electrical charge group Cj are shifted in order in the Y direction of photoelectric conversion element part 242.

When transfer of 48 line parts of electrical charge group C2 from light-shielded region 242-3 is completed, horizontal shift register 244 carries out the horizontal shift operation, and stored electrical charge undergoes serial output to calculation treatment component 250 as a light detection signal S240-1.

Then during step S04 (FIG. 9), 16 line parts of electrical charge group C2 remaining in light-shielded region 242-3 are sent to horizontal shift register 244. Horizontal shift register 244 adds and stores 16 line parts of electrical charge group C2 for each column (Y direction column).

After sending of 16 line parts of electrical charge group C2 to horizontal shift register 244, electrical charge group C10 and junk electrical charge group Cj are also shifted in order in the Y direction of photoelectric conversion element part 242.

At the time when transfer of the 16 line parts of electrical charge group C2 from light-shielded region 242-3 is completed, horizontal shift register 244 carries out the horizontal shift operation, and the stored electrical charge undergoes serial output as a light detection signal S240-2 to calculation treatment component 250.

Here the reason will be explained for two-stage transfer of electrical charge group C2 to horizontal shift register 244 during step S03 and step S04.

In the present working example, results of measurement of plasma light L2 are used for detection of the endpoint of etching of the silicon oxide film layer (that is the layer subject to treatment) and are used for process observation. The 48 lines parts of electrical charge group C2 transferred to horizontal shift register 244 during step S03 are used for detection of the endpoint of etching treatment of the silicon oxide film layer. The 16 line parts of electrical charge group C2 transferred to horizontal shift register 244 during step S04 are used for process observation.

If light intensity of plasma light L2 is high, the 64 line parts of electrical charge group C2, if sent at one time to horizontal shift register 244, are highly likely to overflow by several register units. Since observation of the entire wavelength range of λ1-λ2 of plasma light spectrum L2g is necessary when carrying out process observation, it is necessary that the line count of electrical charge group C2 transferred to horizontal shift register 244 is limited so as not to overflow any register units of horizontal shift register 244. This limit is 16 lines for the present working example.

In contrast, for observation of the endpoint of etching, it is permissible to only pay attention to a specific wavelength λx contained in the total wavelength range λ1-λ2 of plasma light spectrum L2g. Thus it is permissible to adjust the line count of electrical charge group C2 transferred to horizontal shift register 244 in a range such that register units do not overflow at the specific wavelength λx. This is selected as 48 lines for the present working example. In this manner, if line count used to observe etching endpoint is increased as much as possible and is increased to a value higher than the line count for process observation, measurement sensitivity at the specific wavelength λx in plasma light L2 increases, and it becomes possible to detect the endpoint of etching with more precision.

Furthermore, during step S05 (FIG. 10), the electrical charge group C10 transferred to light-shielded region 242-3 from interference light photoreception region 242-1 is sent to horizontal shift register 244. Horizontal shift register 244 adds and stores electrical charge group C10 for each column (Y direction column).

When electrical charge group C10 has been transferred to horizontal shift register 244, the junk electrical charge group Cj is also shifted in order in the Y direction of photoelectric conversion element part 242.

At the time of completion of transfer of electrical charge group C10 from light-shielded region 242-3, the horizontal shift operation is carried out at horizontal shift register 244, and stored electrical charge undergoes serial output as a light detection signal S240-3 to calculation treatment component 250.

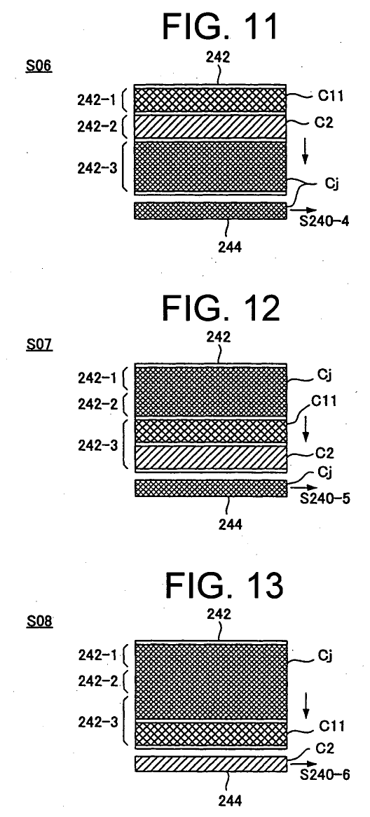

Here during step S06 (FIG. 11), irradiating light L0 from light source 210 is directed toward wafer W. Irradiating light L0 emitted from light source 210 passes through optical fiber 220, passes through widow 161 disposed at the upper part of treatment chamber 102, and strikes the surface of wafer W in the interior of treatment chamber 102. Irradiating light L0, in addition to reflecting from the interface between the silicon oxide film layer (layer subject to treatment) and the mask layer shielding the silicon oxide film layer, also reflects from the bottom surface of a hole formed by etching in the silicon oxide film layer. These two reflected light beams interfere to provide interference light L1 which passes through window 161, through optical fiber 222, and is sent to spectroscopic component 230. Interference light L1 undergoes spectroscopic separation by spectroscopic component 230, and as interference light spectrum L1g strikes interference light photoreception region 242-1 of photoelectric conversion element part 242 belonging to photoelectric conversion component 240. Furthermore, at this time, plasma light spectrum L2g continuously strikes plasma light photoreception region 242-2.

After junk electrical charge Cj is shifted to light-shielded region 242-3 from interference light photoreception region 242-1 and plasma light photoreception region 242-2, the incident interference light spectrum L1g undergoes photoelectric conversion at interference light photoreception region 242-1 and generates an electrical charge group C11. At plasma light photoreception region 242-2, the incident plasma light spectrum L2g undergoes photoelectric conversion and generates an electrical charge group C2.

Junk electrical charge group Cj is sent to horizontal shift register 244 from light-shielded region 242-3. At the time of completion of transfer of junk electrical charge group Cj from light-shielded region 242-3, horizontal shift register 244 undergoes a horizontal shift operation, and the stored electrical charge undergoes serial output as a light detection signal S240-4 to calculation treatment component 250.

Then during step S07 (FIG. 12), the electrical charge group C11 generated in interference light photoreception region 242-1 and the electrical charge group C2 generated in plasma light photoreception region 242-2 are shifted collectively in the Y direction and are stored temporarily in light-shielded region 242-3. Moreover, junk electrical charge group Cj stored in light-shielded region 242-3 is transferred and stored in horizontal shift register 244. At the time when transfer of junk electrical charge group Cj from light-shielded region 242-3 is completed, horizontal shift operation of horizontal shift register 244 is carried out, and the accumulated charge is output as a serial light detection signal S240-5 to calculation treatment component 250.

Even after electrical charge group C11 generated at interference light photoreception region 242-1 and electrical charge group C2 generated at plasma light photoreception region 242-2 are transferred to light-shielded region 242-3, photoelectric conversion elements belonging to interference light photoreception region 242-1 and photoelectric conversion elements belonging to plasma light photoreception region 242-2 generate electrical charge groups. However, since these electrical charge groups are generated during transfer to the previously generated electrical charge group C11 and electrical charge group C2, there is concern that a noise component may be intermixed. Thus these are treated as junk electrical charge groups Cj.

Thereafter during step S08 (FIG. 13), among electrical charge groups transferred to light-shielded region 242-3 from interference light photoreception region 242-1 and plasma light photoreception region 242-2, electrical charge group C2 is transferred to horizontal shift register 244. Horizontal register 244 adds and stores electrical charge group C2 for each column (Y direction column).

After transfer of electrical charge group C2 to horizontal shift register 244, electrical charge group C11 and junk electrical charge group Cj are shifted in order in photoelectric conversion element part 242.

At the time of completion of transfer of electrical charge group C2 from light-shielded region 242-3, the horizontal shift operation is carried out for horizontal shift register 244, and stored electrical charge is output as a serial light detection signal S240-6 to calculation treatment unit 250.

Furthermore, previously during step S03 and step S04, horizontal shift register 244 output light detection signals S240-1 and S240-2 based on electrical charge group C2. Thus calculation treatment component 250 during this step S08 may ignore light detection signal S240-6 output by horizontal sift register 244.

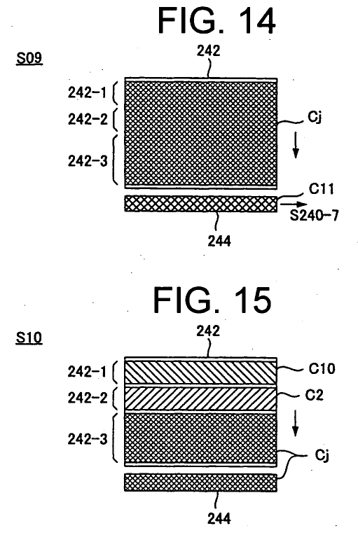

Then during step S09 (FIG. 14), electrical charge group C11 transferred to light-shielded region 242-3 from interference light photoreception region 242-1 is transferred to horizontal shift register 244. Horizontal shift register 244 adds and stores electrical charge group C11 for each column (Y direction column).

After transfer of electrical charge group C11 to horizontal shift register 244, junk electrical charge group Cj is also shifted in order in the Y direction in photoelectric conversion element part 242.

At the time of completion of transfer of electrical charge group C11 from light-shielded region 242-3, the horizontal shift operation is carried out for horizontal shift register 244, and stored electrical charge is output as a serial light detection signal S240-7 to calculation treatment unit 250.

Then just prior to step S10 (FIG. 15), output of irradiating light L0 from light source 210 is halted. Then while irradiating light. L0 is not output from light source 210 (state of non-generation of interference light L1), plasma light L10 passes through window 16 disposed at the upper part of treatment chamber 102, enters optical fiber 222, and is observed. This plasma light L10 undergoes spectroscopic separation by spectroscopic component 230 and strikes interference light photoreception region 242-1 of photoelectric conversion element part 242 belonging to photoelectric conversion component 240. Then this undergoes photoelectric conversion at interference light photoreception region 242-1 to electrical charge group C10.

However, plasma light spectrum L2g continuously strikes plasma light photoreception region 242-2 and there undergoes photoelectric conversion to electrical charge group C2.

The above steps S01-S10 are equivalent to a single cycle of observation of interference light L1 and plasma light L2. By repetition of these steps S01-S10 during etching treatment of the silicon oxide film, interference light L1 and plasma light L2 can be efficiently and precisely measured by photoelectric conversion component 240.

Calculation treatment component 250, based on light detection signal S240 output from horizontal shift register 244 during each step, performs a certain calculation.

For example, calculation treatment component 250 calculates the difference between the light detection signal S240-3 output from horizontal shift register 244 during step S05 and the light detection signal S240-7 output from horizontal shift register 244 during step S09. Based on this difference, the intensity change of interference light L1 is obtained after removal of the effect of plasma P. This change of intensity of interference light L1 makes possible observation of etching rate of the silicon oxide film and detection of the endpoint of etching.

Moreover, plasma light spectrum L2g always strikes plasma light photoreception region 242-2. Multiple photoelectric conversion elements belonging to plasma light photoreception region 242-2 continuously convert plasma light spectrum L2g into electrical charge. However, electrical charge group C10 generated at interference light photoreception region 242-1 passes through this plasma light photoreception region 242-2 during transfer to light-shielded region 242-3. Thus electrical charge group C10 during transfer becomes affected by electrical charge generated in plasma light photoreception region 242-2. However, plasma light spectrum L2g displays constant characteristics during plasma etching treatment. Etching of the silicon oxide film layer that is the layer subject to treatment proceeds, and major change starts at the point in time when the underlying layer is exposed. Thus as mentioned previously, by calculation of the difference between the light detection signal S240-3 output from horizontal shift register 244 during step S05 and the light detection signal S240-7 output from horizontal shift register 244 during step S09, treatment component 250 removes the effect of plasma light spectrum L2g that resulted during passage through plasma light photoreception region 242-2 of electrical charge group C10 generated in interference light photoreception region 242-1. This makes it possible to more accurately obtain of the quantity of electrical charge group C10 as generated at interference light photoreception region 242-1.

Moreover, by comparison of output of light detection signal S240-1 by horizontal shift register 244 of step S03 of a single measurement cycle and output of light detection signal S240-1 by horizontal shift register 244 of step S03 of the following measurement cycle, it is possible to understand the intensity of plasma light L2 at the certain wavelength λx. It can be judged that the silicon oxide film layer (i.e. layer subject to treatment) is exposed when this intensity changes greatly.

By analysis of light detection signal S240-2 output from horizontal shift register 244 during step S04 in wavelength units, it is possible to observe the state of plasma P. Furthermore, it is permissible for this light detection signal S240-2 to contain multiple data obtained at other measurement locations of etching apparatus 100 and for multivariate analysis to be carried out. Real-time observation of the operating state of etching apparatus 100 is realized by use of these analysis results.

As explained previously, by the etching apparatus 100 and by the light detection method used by etching apparatus 100 according to the present working example, photoelectric conversion element part 242 belonging to photoelectric conversion component 240 is provided with multiple photoreception regions (i.e. interference light photoreception region 242-1 and plasma light photoreception region 242-2). Then multiple detected lights (i.e. interference light L1 and plasma light L2) undergo photoreception respectively at interference light photoreception region 242-1 and plasma light photoreception region 242-2. It thus becomes possible to measure and detect interference light L1 and plasma light L2 with efficiency and accuracy by a single photoelectric conversion component 240. Moreover, it is possible to reduce the size of etching apparatus 100 that is capable of measuring light from multiple sources.

Although the plasma treatment apparatus and light detection method of a plasma treatment apparatus were explained while referring to the appended figures for a preferred embodiment of light detection, the present invention is not limited to these examples. One skilled in the art can clearly conceive of various types of modified examples or revised examples falling under the category of technical concepts mentioned in the scope of the patent claims, and it is naturally understood that these also belong to the technical scope of the present invention.

For example, although a working example of the present invention followed the case of measurement of interference light L1 and plasma light L2, according to the present working example, it is also possible to detect and measure other light.

Moreover, the present invention can be also applied to cases of measurement and detection of 3 or more types of light. In this case, the photoelectric conversion element region is preferably divided according to the number of sources of light subject to detection.

It is also possible to simplify structure of the apparatus by omitted the light-shielding means for shielding the light-shielded region provided in the photoelectric conversion element region. By obtaining beforehand characteristics of the light striking this region, it becomes possible by subsequent calculation treatment to remove the effect of incident light on electrical charge transferred through the light-shielded region from the interference light photoreception region and the plasma light photoreception region.

Results of the Invention

According to the present invention as explained above in detail, interference light and plasma light reach the photoelectric conversion element region of the light detection component by passing separately through the respective first light path or second light path. The photoelectric conversion element region is provided with an interference light photoreception region and a plasma light photoreception region. Interference light strikes the interference light photoreception region, and plasma light strikes the plasma light photoreception region. It therefore becomes possible to detect multiple independent optical signals (interference light and plasma light) obtained from multiple locations subject to measurement, and it becomes possible to analyze conditions at each location subject to measurement.

Moreover, according to the present invention, a light-shielded region is provided in the photoelectric conversion element region. By transferring electrical charge groups that have been photoelectrically converted in the interference light photoreception region and the plasma light photoreception region to the light-shielded region, it becomes possible to continuously receive interference light in the interference light photoreception region, and it becomes possible to continuously receive plasma light in the plasma light photoreception region.

What is claimed is:

1. A plasma treatment apparatus for carrying out plasma treatment of a treatment workpiece in a treatment chamber comprising:
a first light path for transmission of interference light obtained by reflection at multiple faces of the treatment workpiece by light striking the treatment workpiece within the treatment chamber;
a second light path for transmission of plasma light generated by plasma formed in the treatment chamber;
a spectroscopic component for spectroscopically separating the interference light and the plasma light; and
a photoelectric conversion component having a photoelectric conversion element region constructed as a two-dimensional array of multiple photoelectric conversion elements for conversion of incident light from the spectroscopic component into electrical charge and an electrical charge storage member for storage of electrical charge sent from the photoelectric conversion element region, wherein the photoelectric conversion element region of the photoelectric conversion component further comprises:
an interference light photoreception region for photoreception of the interference light spectroscopically separated at the spectroscopic component; and
a plasma light photoreception region for photoreception of the plasma light spectroscopically separated at the spectroscopic component, wherein an electrical charge group obtained by photoelectric conversion of the plasma light undergoes time-wise division and is stored in the electrical charge storage member, and among those electrical charge groups obtained by photoelectric conversion of the plasma light, the line count of the photoelectric conversion elements generating the electrical charge group stored in the electrical charge storage member during a single time-division differs from the line count of the photoelectric conversion elements generating the electrical charge group stored in the electrical charge storage member during another time-division.

2. A plasma treatment apparatus according to claim 1, wherein the electrical charge generated by the photoelectric conversion elements belonging to the interference light photoreception region is transmitted to the electrical charge storage member through the plasma light photoreception region.

3. A plasma treatment apparatus according to claim 1, wherein the photoelectric conversion element region further comprises:
a light shield region that overlaps neither the interference light photoreception region nor the plasma light photoreception region.

4. A plasma treatment apparatus according to claim 1, wherein the plasma treatment apparatus further comprises:
a calculation treatment component for calculation of a difference between the quantity of electrical charge generated by the interference light photoreception region when the interference light does not strike the interference light photoreception region and the quantity of electrical charge generated by the interference light photoreception region when the interference light strikes the interference light photoreception region.

5. A light detection method of a plasma treatment apparatus, wherein the plasma treatment apparatus for carrying out plasma treatment of a treatment workpiece in a treatment chamber comprises a first light path for transmission of interference light obtained by reflection at multiple faces of the treatment workpiece by light striking the treatment workpiece within the treatment chamber, a second light path for transmission of plasma light generated by plasma formed in the treatment chamber, a spectroscopic component for spectroscopically separating the interference light and the plasma light, and a photoelectric conversion component having a photoelectric conversion element region constructed as a two-dimensional array of multiple photoelectric conversion elements for conversion of incident light from the spectroscopic component into electrical charge and an electrical charge storage member for storage of electrical charge sent from the photoelectric conversion element region, wherein the light detection method comprising:
receiving, at the interference light photoreception region established in the photoelectric conversion element region, the interference light having been spectroscopically separated by the spectroscopic component; and
receiving, at the plasma light photoreception region established in the photoelectric conversion element region so as to not overlap the interference light photoreception region, the plasma light having been spectroscopically separated by the spectroscopic component, and an electrical charge group obtained by photoelectric conversion of the plasma light undergoes time-wise division and is stored in the electrical charge storage member, wherein among those electrical charge groups obtained by photoelectric conversion of the plasma light, the line count of the photoelectric conversion elements generating the electrical charge group stored in the electrical charge storage member during a single time-division differs from the line count of the photoelectric conversion elements generating the electrical charge group stored in the electrical charge storage member during another time-division.

6. A light detection method of a plasma treatment apparatus according to claim 5, further comprises:
transmitting the electrical change group obtained by photoelectric conversion of the interference light through the plasma light photoreception region from the interference light photoreception region.

7. A light detection method of a plasma treatment apparatus according to claim 5, wherein the photoelectric conversion element region has a light-shielded region that overlaps neither the interference light photoreception region nor the plasma light photoreception region.

8. A light detection method of a plasma treatment apparatus according to claim 5, further comprises:
calculating a difference between the quantity of electrical charge generated by the interference light photoreception region when the interference light does not strike the interference light photoreception region and the quantity of electrical charge generated by the interference light photoreception region when the interference light strikes the interference light photoreception region.

9. A plasma treatment apparatus for carrying out plasma treatment of a treatment workpiece in a treatment chamber comprising:
a first light path for transmission of interference light obtained by reflection at multiple faces of the treatment workpiece by light striking the treatment workpiece within the treatment chamber;
a second light path for transmission of plasma light generated by plasma formed in the treatment chamber;
a spectroscopic component for spectroscopically separating the interference light and the plasma light; and
a photoelectric conversion component comprising a photoelectric conversion element region, including a two-dimensional array of multiple photoelectric conversion elements for conversion of incident light from the spectroscopic component into electrical charge, and an electrical charge storage member for storage of electrical charge sent from the photoelectric conversion element region, wherein the photoelectric conversion element region of the photoelectric conversion component further comprises:
an interference light photoreception region for photoreception of spectroscopically separated interference light from the spectroscopic component; and
a plasma light photoreception region for photoreception of spectroscopically separated plasma light from the spectroscopic component, wherein an electrical charge group obtained by photoelectric conversion of the spectroscopically separated plasma light undergoes time-wise division and is stored in the electrical charge storage member, and among those electrical charge groups obtained by photoelectric conversion of the spectroscopically separated plasma light, the line count of the photoelectric conversion elements generating the electrical charge group stored in the electrical charge storage member during a single time-division differs from the line count of the photoelectric conversion elements generating the electrical charge group stored in the electrical charge storage member during another time-division.

10. A light detection method implemented in a plasma treatment apparatus, the plasma treatment apparatus for carrying out plasma treatment of a treatment workpiece in a treatment chamber comprising a first light path for transmission of interference light obtained by reflection at multiple faces of the treatment workpiece by light striking the treatment workpiece within the treatment chamber, a second light path for transmission of plasma light generated by plasma formed in the treatment chamber, a spectroscopic component for spectroscopically separating the interference light and the plasma light, and a photoelectric conversion component having a photoelectric conversion element region constructed as a two-dimensional array of multiple photoelectric conversion elements for conversion of incident light from the spectroscopic component into electrical charge and an electrical charge storage member for storage of electrical charge sent from the photoelectric conversion element region, wherein the light detection method comprising:
receiving spectroscopically separated interference light at the interference light photoreception region established in the photoelectric conversion element region; and
receiving spectroscopically separated plasma light at the plasma light photoreception region established in the photoelectric conversion element region such that the spectroscopically separated plasma light is not received on the interference light photoreception region;
time-wise subdividing an electrical charge group obtained by photoelectric conversion of the spectroscopically separated plasma light into at least a first subdivided electrical charge group obtained by a first line count of the photoelectric conversion elements generating the electrical charge and a second subdivided electrical charge group obtained by a second line count of the photoelectric conversion elements generating the electrical charge, wherein the first line count differs from the second line count; storing the first subdivided electrical charge group in the electrical charge storage; and
storing the second subdivided electrical charge group in the electrical charge storage.

11. A light detection method of a plasma treatment apparatus according to claim 10, further comprises:
transmitting the electrical change group obtained by photoelectric conversion of the interference light, through the plasma light photoreception region from the interference light photoreception region, to the electrical charge storage.
